(19) United States
(12) Patent Application Publication
(10) Pub. No.: US 2007/0179825 A1
(43) Pub. Date: Aug. 2, 2007

(54) Method of configuring a process model

(76) Inventors: Alexander Dreiling, Kelvin Grove (AU); Michael Rosemann, Windsor (AU); Karsten A. Schulz, Middle Park (AU); Wasim Sadiq, Pullenvale (AU)

Correspondence Address: PERKINS COIE LLP, P.O. BOX 2168, MENLO PARK, CA, 94026, US

(21) Appl. No.: 11/344,952

(22) Filed: Jan. 31, 2006

(51) Int. Cl. G06F 9/44

(52) U.S. Cl. 705/7

(57) ABSTRACT

In various embodiments, a system, method and apparatus is provided for configuring a process model. In an embodiment, a method is provided. The method includes receiving management information related to a process. The method also includes receiving business information related to the process. The method further includes receiving technical information related to the process. Additionally, the method includes adapting a generic process model into a specific process model to reflect the management information, business information and technical information. Moreover, the method includes storing the specific process model in a data repository for an enterprise application.

### CROSS-REFERENCE TO RELATED APPLICATION

None

### BACKGROUND

Enterprise systems work with a variety of different parts of a company. Preferably, an enterprise system allows for modeling and improvement of company processes at all levels of a company. Thus, an enterprise system may allow for standardization and efficient implementation of customer tracking or new hire inclusion in a company, for example. Similarly, an enterprise system may allow for insights into company processes from various levels of management. Moreover, an enterprise system may allow for operation of company processes by a variety of employees with varying levels of training or expertise, for example.

The enterprise system typically uses a model of a process. The process model can provide an overview of the process, thus providing a management tool. The process model can also provide a detailed description of the process for business analysts (and effectively for participants). Moreover, the process model can provide a specification as to how an enterprise system and information technology (IT) group will support the process in terms of computing resources.

However, to achieve this, company processes must be modeled for the enterprise system. This may include something as simple as a software model of a process for handling a customer contact. This may also include more complicated models, such as models of company financials and the various inputs producing a balance sheet or income statement, for example. Processes and organizations of a company must be modeled in a manner such that software can work with the model. However, data structures useful for such models are rarely intelligible to a user. Thus, it may be useful to provide tools for building or customizing models in an enterprise system.

### SUMMARY

A system, method and apparatus is provided for configuring a process model. In an embodiment, a method is provided. The method includes receiving management information related to a process. The method also includes receiving business information related to the process. The method further includes receiving technical information related to the process. Additionally, the method includes adapting a generic process model into a specific process model to reflect the management information, business information and technical information. Moreover, the method includes storing the specific process model in a data repository for an enterprise application.

In another embodiment, a system is provided. The system includes a management configuration module to receive management structure data. The system also includes a business analysis module to receive business process data. The system further includes a technical analysis module to receive technical process data. The system includes an adaptation module to adapt a generic process responsive to data of the management configuration module, business analysis module and technical analysis module.

In another embodiment, a method of configuring process models in a data repository related to users of an enterprise application in a company is provided. The method includes receiving business information related to a process. Also, the method includes receiving management information related to the process. Moreover, the method includes receiving technical information related to the process. Additionally, the method includes reducing a generic process model into a specific process model responsive to indications from the management information, business information and technical information that portions of the generic process model are not necessary. The method also includes adapting the generic process model into the specific process model to reflect the management information, business information and technical information. The method further includes storing the specific process model in the data repository.

In still another embodiment, an apparatus is provided. The apparatus includes means for receiving management information related to a process. Additionally, the apparatus includes means for receiving business information related to the process. Also, the apparatus includes means for receiving technical information related to the process. Moreover, the apparatus includes means for adapting a generic process model into a specific process model to reflect the management information, business information and technical information. The apparatus further includes means for reducing the generic process model into the specific process model. The means for reducing operates responsive to indications from the management information, business information and technical information that portions of the generic process model are not necessary. The apparatus also includes means for storing the specific process model in a data repository for an enterprise application.

In yet another embodiment, a method is provided. The method includes initially selecting a configurable process model for a process. The method further includes receiving management information related to the process responsive to a questionnaire. The method also includes receiving business information related to the process responsive to a questionnaire and receiving technical information related to the process responsive to a questionnaire. Also, the method includes comparing responses to questionnaires to perspective data related to the configurable process model. Furthermore, the method includes adapting the configurable process model into a specific process model to reflect the management information, business information and technical information and thereby reflect the process. Moreover, the method includes storing the specific process model in a data repository for an enterprise system.

In still another embodiment, a system is provided. The system includes a set of configurable process models embodied in a repository. The system further includes a model reduction and configuration module to produce custom process models from the configurable process models. Additionally, the system includes a set of process model data repositories to provide data to the model reduction and configuration module. Also, the system includes an enterprise system to operate with custom process models.

### BRIEF DESCRIPTION OF THE DRAWINGS

The present invention is illustrated in an exemplary manner by the accompanying drawings. The drawings should be understood as exemplary rather than limiting, as the scope of the invention is defined by the claims.

FIG. 1 illustrates an embodiment of a generic process model.

FIG. 2 illustrates an embodiment of a customized process model.

FIG. 3 illustrates an embodiment of a system for customizing a process model.

FIG. 4 illustrates an embodiment of a medium embodying instructions which may be useful in customizing a process model.

FIG. 5 illustrates an embodiment of a process of customizing a process model.

FIG. 6 illustrates an embodiment of a hierarchy of process models.

FIG. 7 illustrates an embodiment of a network which may be used with an enterprise software system and associated models.

FIG. 8 illustrates an embodiment of a system which may be used in the network of FIG. 7 with an enterprise software system and associated models.

FIG. 9 illustrates an embodiment of a system including an enterprise software application and modeling module.

FIG. 10 illustrates an alternate embodiment of a process of modeling company processes.

FIG. 11A illustrates an embodiment of a process which may be customized.

FIG. 11B illustrates the process of FIG. 11A after customization in one embodiment.

FIG. 12A illustrates another embodiment of a process which may be customized.

FIG. 12B illustrates the process of FIG. 12A after customization in one embodiment.

FIG. 13A illustrates yet another embodiment of a process which may be customized.

FIG. 13B illustrates the process of FIG. 13A after customization in one embodiment.

FIG. 14A illustrates still another embodiment of a process which may be customized.

FIG. 14B illustrates the process of FIG. 14A after customization in one embodiment.

FIG. 14C illustrates the process of FIG. 14B after further customization in one embodiment.

FIG. 15A illustrates another embodiment of a process which may be customized.

FIG. 15B illustrates an alternate embodiment of the process of FIG. 15A which may be customized.

FIG. 15C illustrates the process of FIG. 15A after customization in one embodiment.

FIG. 15D illustrates the process of FIG. 15B after customization in one embodiment.

FIG. 15E illustrates the resulting process of customization of the processes of FIG. 15A and 15B after customization in one embodiment.

FIG. 16 illustrates various approaches to customizing a process in various embodiments, and how combinations of such approaches provide an enhanced effect.

FIG. 17 illustrates an embodiment of a process and a customized process.

FIG. 18 illustrates an embodiment of a system using customized models and the related parts of the system used to produce customized models.

FIG. 19 illustrates an embodiment of a process of customizing a generic model to provide a customized model.

FIG. 20 illustrates an alternate embodiment of a process of customizing a generic model to provide a customized model.

### DETAILED DESCRIPTION

A system, method and apparatus is provided for configuring a process model. The specific embodiments described in this document represent instances of the present invention, and are illustrative in nature rather than restrictive. A process model configuration process is provided. A process model may be useful in guiding enterprise software in its interactions with users in a given company. Configuring a process model involves gathering information about the process itself. This may include gathering management or organizational information, gathering business information and gathering technical information. This may further involve taking a generic process and trimming and/or adapting the generic process to the information gathered. Furthermore, this may involve iterating the process several times to get the model correct, potentially with feedback from a user.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

In an embodiment, a method is provided. The method includes receiving management information related to a process. The method also includes receiving business information related to the process. The method further includes receiving technical information related to the process. Additionally, the method includes adapting a generic process model into a specific process model to reflect the management information, business information and technical information. Moreover, the method includes storing the specific process model in a data repository for an enterprise application.

In another embodiment, a system is provided. The system includes a management configuration module to receive management structure data. The system also includes a business analysis module to receive business process data. The system further includes a technical analysis module to receive technical process data. The system includes an adaptation module to adapt a generic process responsive to data of the management configuration module, business analysis module and technical analysis module.

In another embodiment, a method of configuring process models in a data repository related to users of an enterprise application in a company is provided. The method includes receiving business information related to a process. Also, the method includes receiving management information related to the process. Moreover, the method includes receiving technical information related to the process. Additionally, the method includes reducing a generic process model into a specific process model responsive to indications from the management information, business information and technical information that portions of the generic process model are not necessary. The method also includes adapting the generic process model into the specific process model to reflect the management information, business information and technical information. The method further includes storing the specific process model in the data repository.

In still another embodiment, an apparatus is provided. The apparatus includes means for receiving management information related to a process. Additionally, the apparatus includes means for receiving business information related to the process. Also, the apparatus includes means for receiving technical information related to the process. Moreover, the apparatus includes means for adapting a generic process model into a specific process model to reflect the management information, business information and technical information. The apparatus further includes means for reducing the generic process model into the specific process model. The means for reducing operates responsive to indications from the management information, business information and technical information that portions of the generic process model are not necessary. The apparatus also includes means for storing the specific process model in a data repository for an enterprise application.

In yet another embodiment, a method is provided. The method includes initially selecting a configurable process model for a process. The method further includes receiving management information related to the process responsive to a questionnaire. The method also includes receiving business information related to the process responsive to a questionnaire and receiving technical information related to the process responsive to a questionnaire. Also, the method includes comparing responses to questionnaires to perspective data related to the configurable process model. Furthermore, the method includes adapting the configurable process model into a specific process model to reflect the management information, business information and technical information and thereby reflect the process. Moreover, the method includes storing the specific process model in a data repository for an enterprise system.

In still another embodiment, a system is provided. The system includes a set of configurable process models embodied in a repository. The system further includes a model reduction and configuration module to produce custom process models from the configurable process models. Additionally, the system includes a set of process model data repositories to provide data to the model reduction and configuration module. Also, the system includes an enterprise system to operate with custom process models.

Process models may initially be generic in nature, allowing for future customization. FIG. 1 illustrates an embodiment of a generic process model. Process model 100 includes a series of modules in an uncustomized form. Thus, modules P1, P2, P3, P4, P5 through Pn−1, Pn and Pn+1 (among other modules) all represent portions of a process model. Such a process model may relate to various company activities, such as handling a customer contact, adding a new hire or approving a new product, for example. Each of the modules may represent a discrete portion of the overall process, allowing for modeling of data input, processing of data, presentation of collected data, receipt of decisions, and updates to data storage systems, for example.

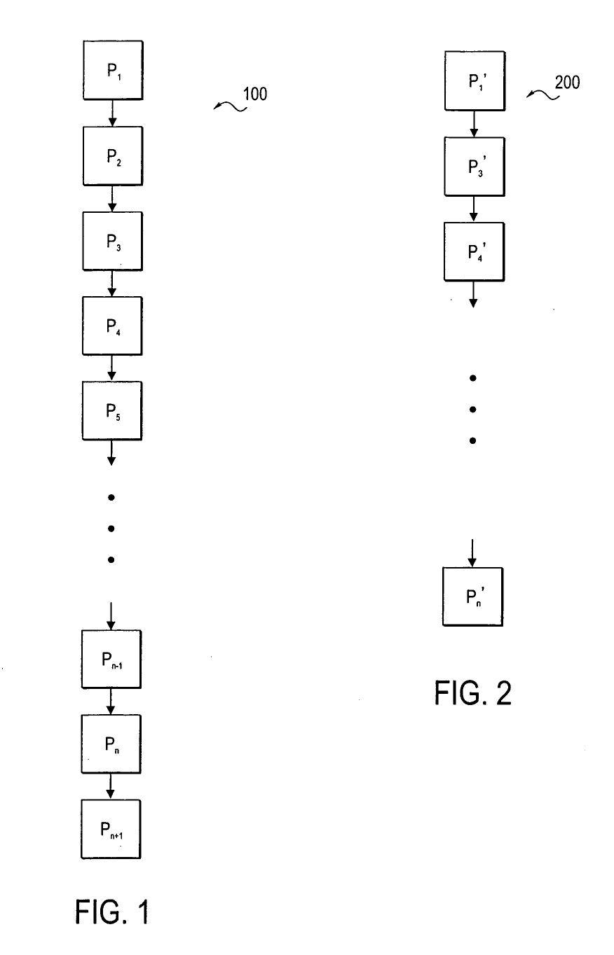

A customized process model may use some of a generic process model, with other parts of the generic process model either deleted or switched off through software/data flags, for example. FIG. 2 illustrates an embodiment of a customized process model. A customized process model 200 includes modules P1′, P3′, P4′ and Pn′, among other modules. The modules P1′, P3′, P4′ and Pn′ may be expected to be customized versions of modules P1, P3, P4 and Pn, reflecting specifics of a process to be modeled. Modules not included may be those which were not important to the process, or simply not involved in the process, and thus not necessary for modeling. Not specifically illustrated is the possibility of reordering process modules within a model, which may be appropriate when modules fit the process in a different order from that found in a generic process model, for example. Also not specifically illustrated is a hierarchical system of process. Thus, a process module P3′, for example, may represent a sub-process which is a self-contained process in its own right.

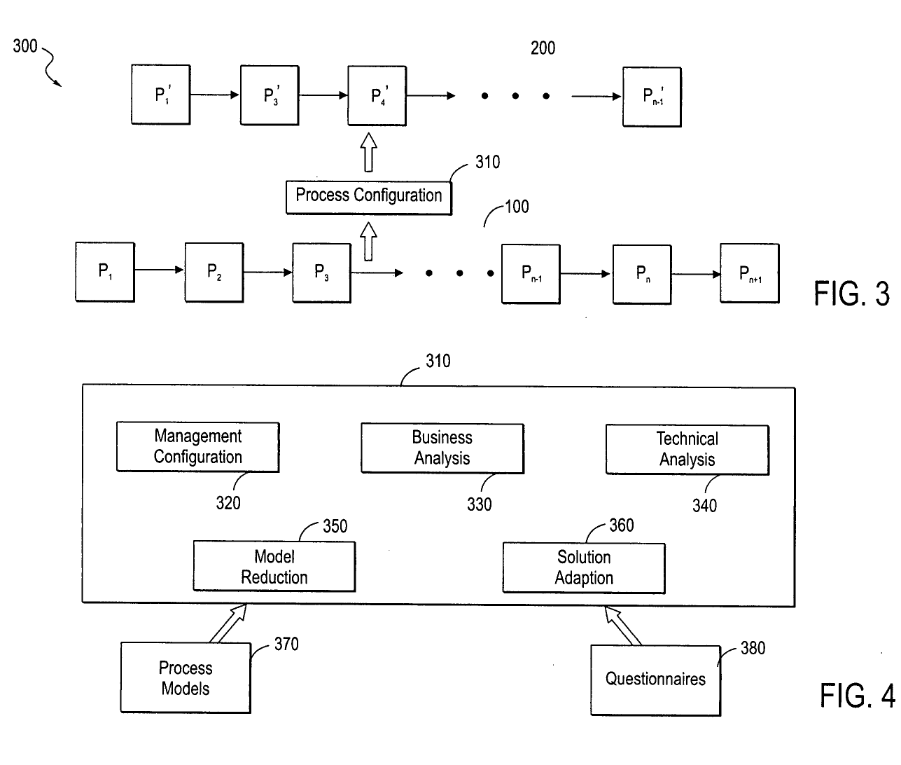

Going from a generic process model to a specific process model typically involves some form of customization. FIG. 3 illustrates an embodiment of a system for customizing a process model. System 300 uses a process configuration module 310 to take a generic process 100 and produce a customized process 200. Module 310 may be a process module such as software or may be implemented in hardware, for example. FIG. 4 illustrates an embodiment of a medium embodying instructions which may be useful in customizing a process model. Module 310 is illustrated in one embodiment. Each of modules 320, 330, 340, 350 and 360 may be included as part of module 310 in such an embodiment, and be part of instructions in a machine-readable medium.

Management configuration module 320 receives information about overall process configuration from a user and applies that to a generic or partially customized process model. Business analysis module 330 receives information about business processes from a user and applies that to the process model. Similarly, technical analysis module 340 receives information about technical aspects of a process from a user and applies that information to the process model. Thus, modules 320, 330 and 340 may be expected to collect information about processes and make changes to a process model responsive to the information collected. In particular, business analysis module 330 may receive information about who makes decisions in a process, or who information comes from or goes to. Similarly, technical analysis module 340 may receive information about data formats and types of information provided. Management configuration module 320 may receive information about the relationships between personnel and about relationships between processes.

With information about the process in the system, model reduction module 350 may remove unnecessary parts of a process model—deleting unused steps and redundant parts of a model, for example. Similarly, module 360 may adapt process models, by reordering parts of the model responsive to information received, or otherwise rearranging the model. Modules 350 and 360 may allow for more efficient representations of process information. Moreover, operations may occur in an ongoing process, with feedback involved, such that after a model is reduced and adapted by modules 350 and 360, more data can be gathered based on user reviews of the process through modules 320, 330 and 340, for example. All of this may occur through use of generic process models 370, and may be augmented by standard questionnaires 380, which may serve as a starting point for information gathering.

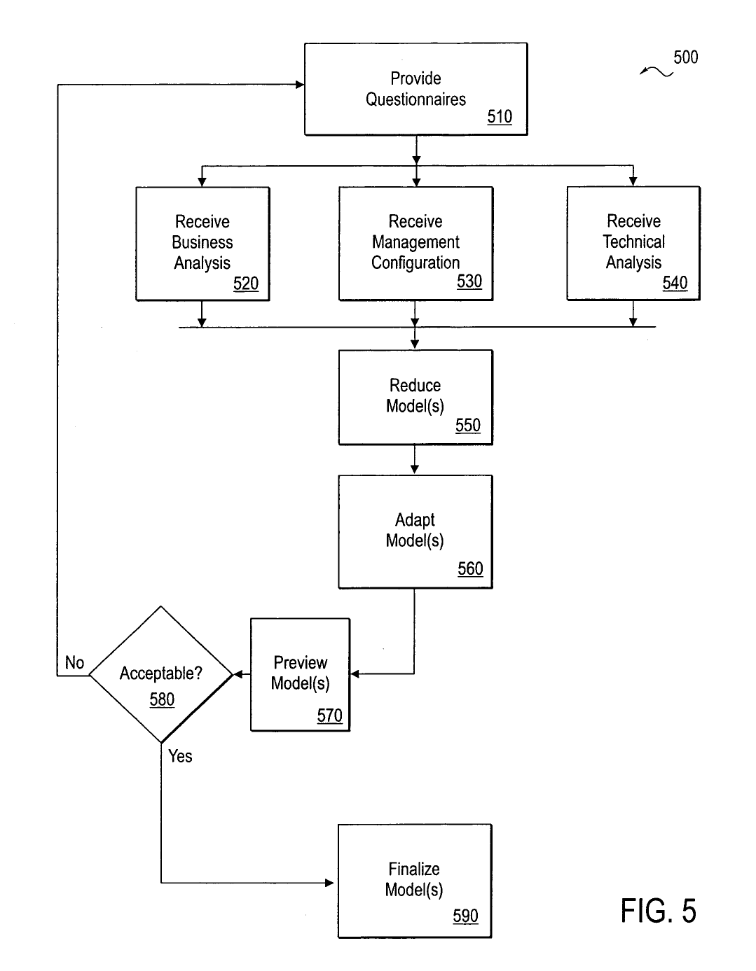

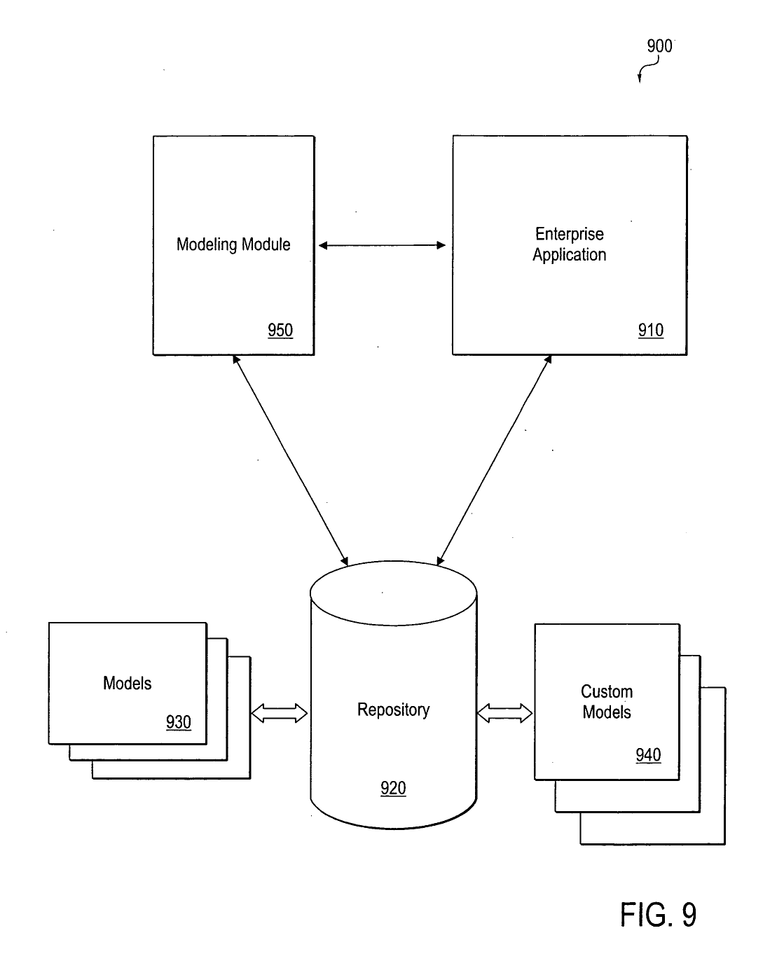

Various processes may be used to customize a process model. Process 500 may be implemented by module 310, for example, or by other systems such as that of FIG. 9, for example. FIG. 5 illustrates an embodiment of a process of customizing a process model. Process 500 includes providing questionnaires to users, receiving information on business analysis, management configuration and technical analysis, reducing a model, adapting a model, previewing the model, and determining if the model is complete. Process 500 and other processes of this document are implemented as a set of modules, which may be process modules or operations, software modules with associated functions or effects, hardware modules designed to fulfill the process operations, or some combination of the various types of modules, for example. The modules of process 500 and other processes described herein may be rearranged, such as in a parallel or serial fashion, and may be reordered, combined, or subdivided in various embodiments.

Process 500 initiates at module 510 with provision of questionnaires to users. This may be accomplished through a user interface with a question and answer format, for example. Alternatively, questions may be posed in a more abstract manner, such as by allowing a user to manipulate graphical symbols for parts of a process to indicate how a process works. As a result of answers to questions or other input from users, at module 520, business analysis of a process, such as who is involved and who makes decisions, is received. Similarly, at module 530, management configuration information is received, such as the relationships between people involved in a process (and corresponding access options), for example. Moreover, at module 540, technical analysis information is received, such as information about the type of data involved in a process, and data sources or output formats, for example. Additionally, feedback between modules 520, 530 and 540 on one side and module 510 on the other side may result in specific information being requested.

As a result of information received, at module 550, a process model in question is reduced, by eliminating or turning off portions of the model not required for the specific process in question. Likewise, at module 560, the process model is adapted to information received, such as by reordering or rearranging parts of the process model, for example. At module 570, the updated process model is presented to the user or users for further review. At this time, a determination is made as to whether the process has been adequately modeled at module 580. If not, the process returns to module 510 for a new round or repeat of questionnaires. If the process is adequately modeled, the model is stored at module 590, thereby finalizing the modeling process.

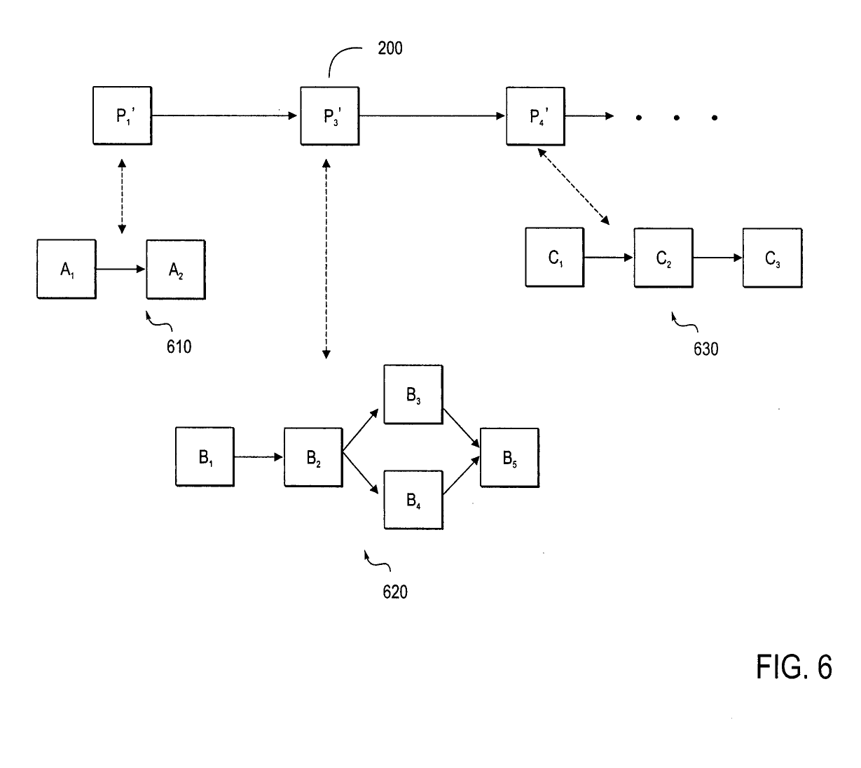

It has been pointed out that hierarchical processes and models may be used. FIG. 6 illustrates an embodiment of a hierarchy of process models. Process 200 is a process model at a high level. Each of modules P1′, P3′ and P4′ actually represent different processes incorporated as single modules in process 200. Thus, process 610, composed of modules A1 and A2 provides module P1′. Similarly, process 620, composed of modules B1, B2, B3, B4 and B5, provides module P3′. Likewise, process 630, composed of modules C1, C2 and C3, provides module P4′. As is also apparent, processes need not be entirely linear. In addition to the alternate paths of process 620, loops, branches and parallel execution may be incorporated in process models.

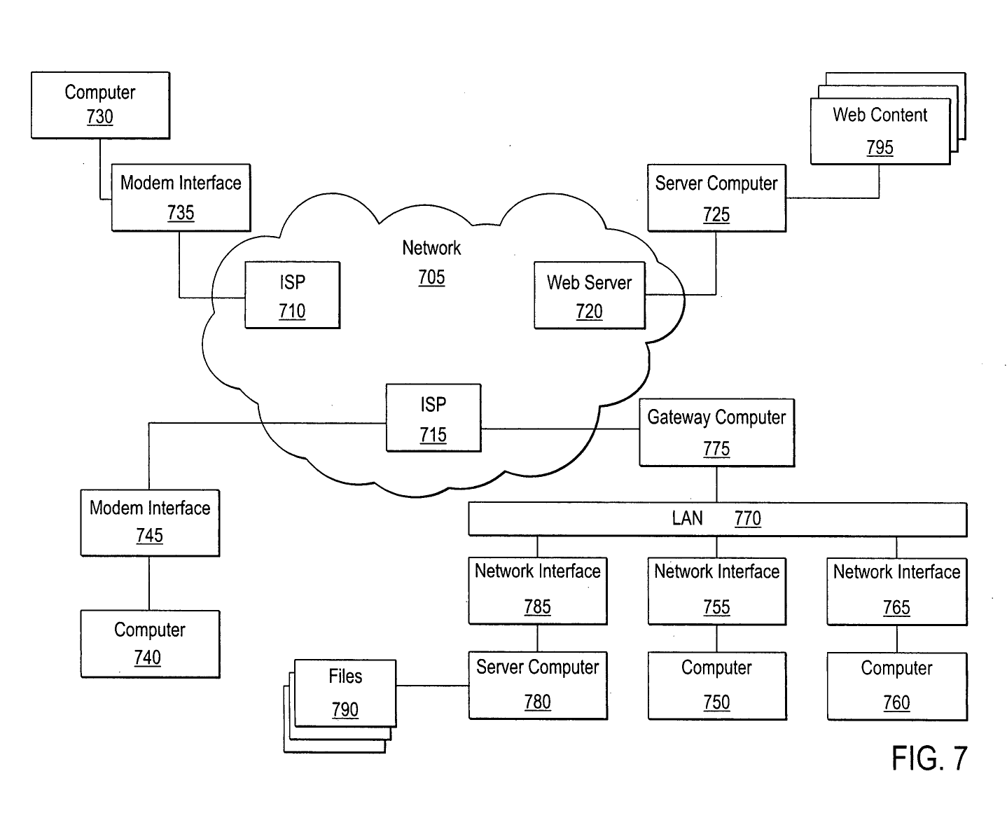

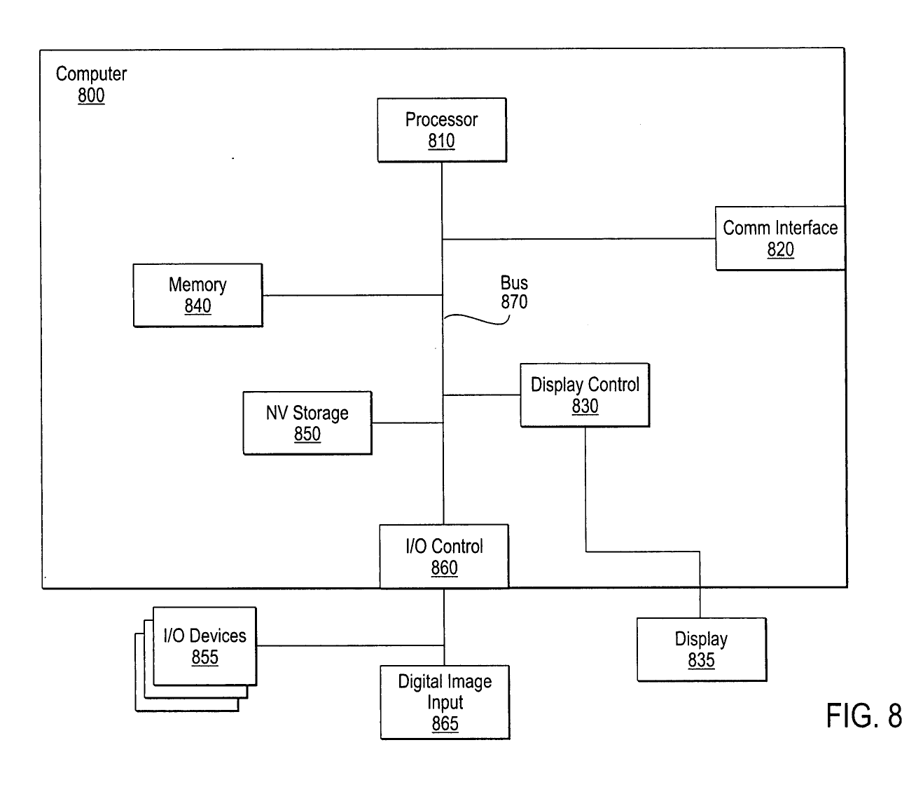

The following description of FIGS. 7-8 is intended to provide an overview of computer hardware and other operating components suitable for performing the methods of the invention described above and hereafter, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet. The term “internet” as used herein refers to a network of networks which uses certain protocols, such as the tcp/ip protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 705 is typically provided by internet service providers (ISP), such as the ISPs 710 and 715. Users on client systems, such as client computer systems 730, 740, 750, and 760 obtain access to the internet through the internet service providers, such as ISPs 710 and 715. Access to the internet allows users of the client computer systems to exchange information, receive and send e-mails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet. Optionally, the web server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides internet connectivity to the client computer system 730 through the modem interface 735 which can be considered part of the client computer system 730. The client computer system can be a personal computer system, a network computer, a web tv system, or other such computer system.

Similarly, the ISP 715 provides internet connectivity for client systems 740, 750, and 760, although as shown in FIG. 7, the connections are not the same for these three computer systems. Client computer system 740 is coupled through a modem interface 745 while client computer systems 750 and 760 are part of a LAN. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other internet related services for the local area network. This gateway computer system 775 is coupled to the ISP 715 to provide internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the internet through the gateway system 775.

FIG. 8 shows one example of a conventional computer system that can be used as a client computer system or a server computer system or as a web server system. Such a computer system can be used to perform many of the functions of an internet service provider, such as ISP 710. The computer system 800 interfaces to external systems through the modem or network interface 820. It will be appreciated that the modem or network interface 820 can be considered to be part of the computer system 800. This interface 820 can be an analog modem, isdn modem, cable modem, token ring interface, satellite transmission interface (e.g. “direct PC”), or other interfaces for coupling a computer system to other computer systems.

The computer system 800 includes a processor 810, which can be a conventional microprocessor such as an Intel pentium microprocessor or Motorola power PC microprocessor. Memory 840 is coupled to the processor 810 by a bus 870. Memory 840 can be dynamic random access memory (dram) and can also include static ram (sram). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). The input/output devices 855 can include a keyboard, disk drives, printers, a scanner, and other input and output devices, including a mouse or other pointing device. The display controller 830 and the I/O controller 860 can be implemented with conventional well known technology. A digital image input device 865 can be a digital camera which is coupled to an i/o controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash. and their associated file management systems. Another example of an operating system software with its associated file management system software is the Linux operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

Various systems, media and devices may be used with systems such as those of FIGS. 7 and 8, for example. FIG. 9 illustrates an embodiment of a system including an enterprise software application and modeling module. System 900 includes an enterprise software application, data repository, process models, custom process models, and a process model maintenance module. Other modules may also be incorporated as needed in various enterprise software environments. Thus, enterprise application 910 may be a customer relations management application or other large-scale enterprise software application, for example. Application 910 may be expected to operate based on a model of processes a company undergoes, for example. Repository 920 may be a database repository, including custom process models 940 and generic process models 930 among its data and/or metadata, for example. Thus, enterprise application 910 may access information in repository 920 to determine how to interact with users at a specific company related to repository 920, for example.

Process modeling module 950 provides a component which assists in providing custom process models 940, based on generic process models 930. Thus, process modeling module 950 may gather business and technical data to determine how custom process models 940 should represent processes of a company. Similarly, module 950 may prune or rearrange parts of a custom process model 940 based on such information. Moreover, module 950 may be used to maintain such models 940 as processes change over time, for example. Module 950 may implement various processes to achieve these results, such as process 500 of FIG. 5, for example.

Module 950 may implement a process such as process 1000, for example. FIG. 10 illustrates an alternate embodiment of a process of modeling company processes. Process 1000 includes initiation, presenting a current model, querying for management structure and receiving data, querying for business processes and receiving data and querying for technical processes and receiving data. Process 1000 further includes reducing a process model, adapting the process model, and previewing the process model for approval. Process 1000 also includes a determination as to whether the model is correct, recording the model, and determining if other models need to be customized.

Process 1000 initiates at module 1010 with initial operations such as selection of a generic process from which to start. At module 1020, the current model (either as modified or in generic form) is presented to the user. At module 1030, queries are presented relating to management structure associated with the process. Data related to these queries is received at module 1035. Similarly, queries about business processes of the process are presented at module 1040, with data received therefrom at module 1045. Likewise, queries related to technical aspects of the process are presented at module 1050, with data received at module 1055.

With this data, the model is then reduced at module 1060, with unnecessary portions excised or switched off in various embodiments. At module 1065, the model is adapted, such as by reordering parts of the process or rearranging parts into parallel, serial, or branching portions of a process. At module 1070, the reconfigured process model is previewed for the user. Note that in some embodiments, this may occur at other parts of the process 1000, such as in conjunction with data gathering modules 1030, 1040 and 1050, or as part of a graphical user interface used to gather information through interactions other than queries.

At module 1080, a determination is made as to whether the present process model is correct as understood by the user. If not, the process model is presented for further manipulation or provision of new or different information at module 1020. If the model is correct, the model is then recorded (stored) in the repository at module 1085. At module 1090, a determination is then made as to whether other processes need to be modeled. This may relate to sub-processes or other unrelated processes, for example. If so, the modeling process re-initiates at module 1010. If not, the modeling process terminates at termination point 1095. Note that the modules of process 1000 and the modules of process 500 may be used together to form similar processes with a variety of related features, and with different organizations (parallel vs. serial implementation, for example).

A discussion of how processes are customized may further illustrate the effect of using multiple customization methods to achieve a desired result. Different customization methods or operations are available, and have been discussed somewhat. The following further illuminates some aspects of these methods or operations. The options include use of best practices or perspectives based on users of a process, use of a configurable process in general, use of questionnaires to determine what will be involved in a process, and reduction of models (as well as configuration) to produce a customized process model.

Configurable process models typically are process models with many different options included, from which a user or a customizing engine can pick and choose. Configurability can include specifying options or rearranging process flow, for example. Model reduction can involve pruning unused modules from a process model, such as through selection by a user, flagging by automatic review, or through detection of branches which can never be taken, for example.

Questionnaires can provide a predetermined approach to how a process should be customized—allowing a user to answer a set of questions and to thereby determine how a process model should be shaped. Perspectives based on how other processes have been customized can be built in with a variety of options. Thus, certain industries may start with certain process models, as may certain countries. Additionally, certain process modules (components of a process model or process) may have information attached indicating they are likely to be used or particularly unlikely, or are only suited to certain scenarios, for example. Perspectives can thus be triggered based on responses to questionnaires, for example.

Use of questionnaires, perspective data, configurable models and model reduction can produce a gestalt-like result. The whole of the process is greater than the sum of its results. For example, a simple questionnaire combined with perspective data and a well-chosen configurable process model may result in an easily reduced model which provides the desired custom process model. In contrast, working only with questionnaires may require many iterations and further customization.

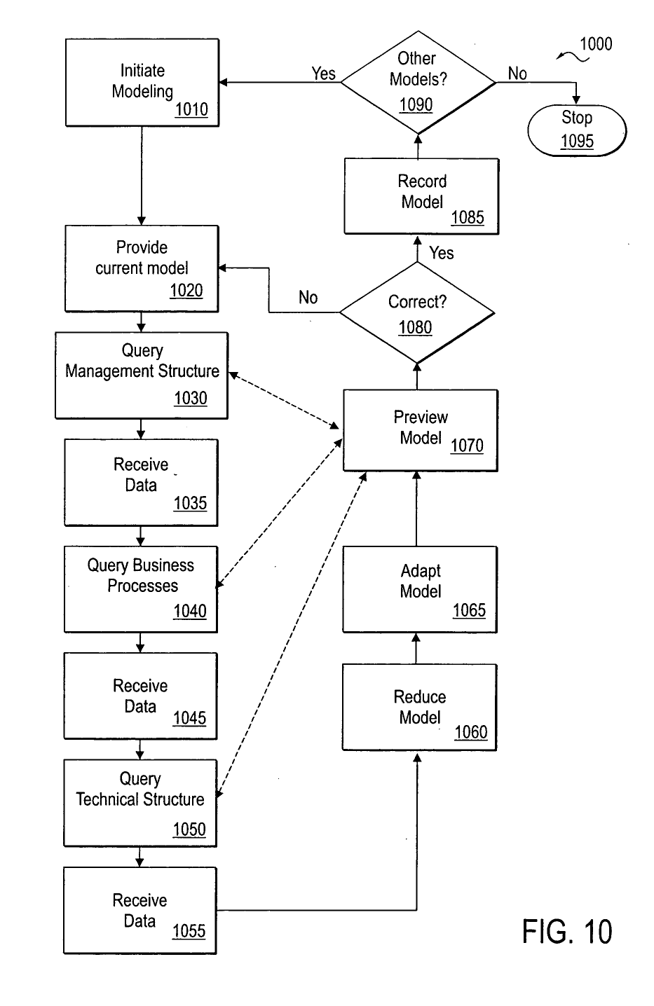

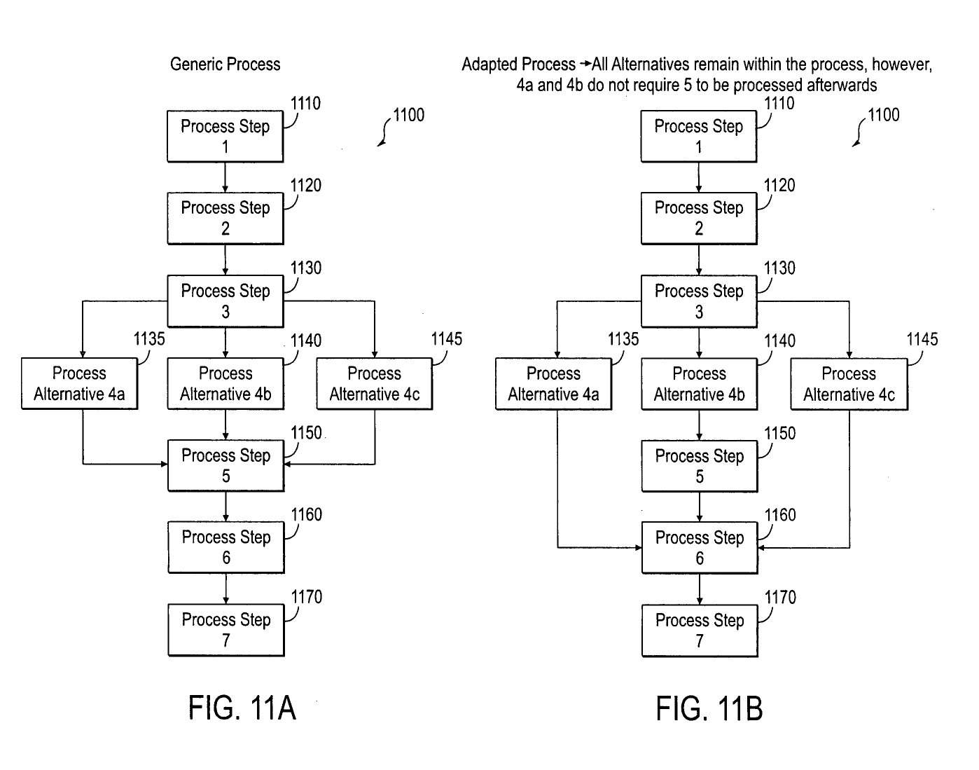

Examples of processes with customized form may enhance this explanation. FIG. 11A illustrates an embodiment of a process which may be customized. As illustrated, process 1100 includes an initial series of process steps 1, 2 and 3 (modules 1110, 1120 and 1130). Next, a set of options are available as one of process steps 4a, 4b and 4c (modules 1135, 1140 and 1145). The process culminates with process steps 5, 6 and 7 (modules 1150, 1160 and 1170). One method of adaptation of such a generic process 1100 is to alter the process flow due to differences in what is required for a specific process.

FIG. 11B illustrates the process of FIG. 11A after customization in one embodiment. As adapted, process steps 4a and 4c do not require the process to then flow to process step 5—rather, the process can move to process step 6. Thus, the process is customized to a specific implementation from the more generic starting point. This customization may relate to a type of payment, for example, where one type of payment such as a direct payment from a bank requires an extra initial authorization step, and other types of payment, such as a credit card or debit card does not require such an extra step. Other forms of customization may also be used in such instances.

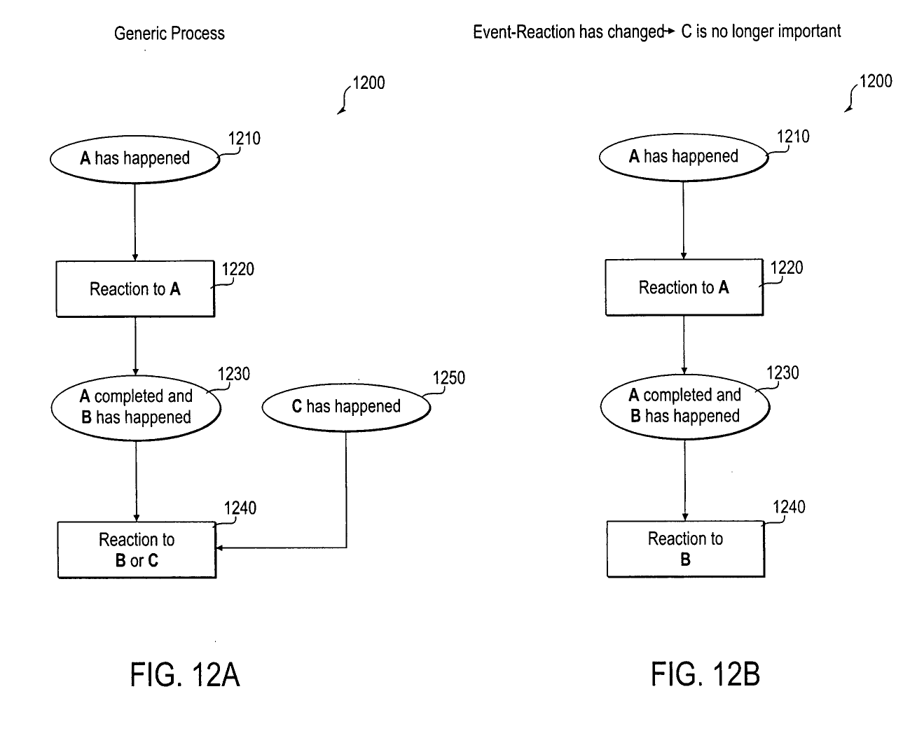

Other customizations of processes may occur. For example, customization may occur because an event is not relevant for a specific process. FIG. 12A illustrates another embodiment of a process which may be customized. Process 1200, in customizable form, includes identifying event A (module 1210), reacting to event A (module 1220), identifying event B. (module 1230), alternatively identifying event C (module 1240), and reacting to events B/C (module 1250). Customization may occur because one of these events is not relevant in a particular context. FIG. 12B illustrates the process of FIG. 12A after customization in one embodiment. As modified, process 1200 in FIG. 12B does not contemplate event C, and module 1250 has been removed. In practice, this translates into an event that requires no more reaction, i.e., an irrelevant event in the specific organizational setting.

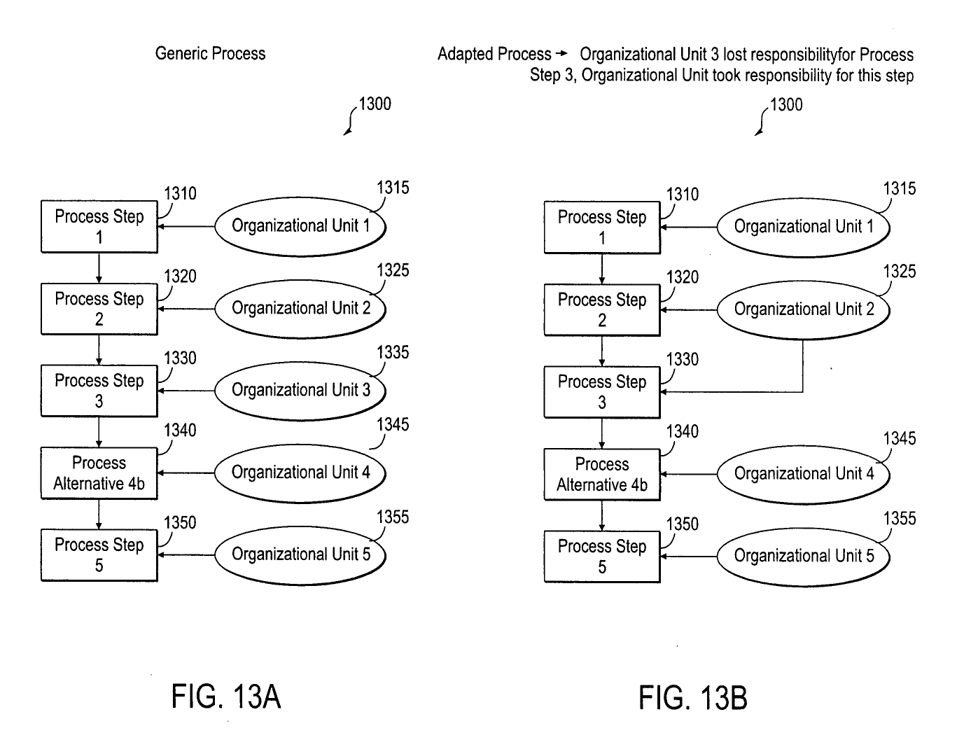

Customizations may also occur due to differences in structure of organizations implementing a process. FIG. 13A illustrates yet another embodiment of a process which may be customized. Process 1300 includes process steps 1, 2, 3, 4 and 5 (modules 1310, 1320, 1330, 1340 and 1350). Each of these process steps is related to an organizational unit—such as through input provided from the organizational unit or through performance of the step by the organizational unit. Thus, organizational unit 1 (module 1315) relates to process step 1, organizational unit 2 (module 1325) relates to process step 2, organizational unit 3 (module 1335) relates to process step 3, organizational unit 4 (module 1345) relates to process step 4, and organizational unit 5 (module 1355) relates to process step 5. Relationships here may indicate the organizational unit executes the step or is responsible for the step in some way.

This generic approach may be expected to be appropriate for some parts of an industry, for example, and to represent a useful jumping off point for other parts of the same industry, for example. FIG. 13B illustrates the process of FIG. 13A after customization in one embodiment. For a company in an industry with a different organization, not all of the organizational units may be present. As such, in the customized version of process 1300 of FIG. 13B, both of process steps 2 and 3 (modules 1320 and 1330) are related to organizational unit 2 (module 1325), and no organizational unit 3 is present. Note that these examples could cover a strict segregation of duties in the financial sector, whereas such a distribution of power would not be necessary in organizations outside the financial sector, or even within parts of the financial sector.

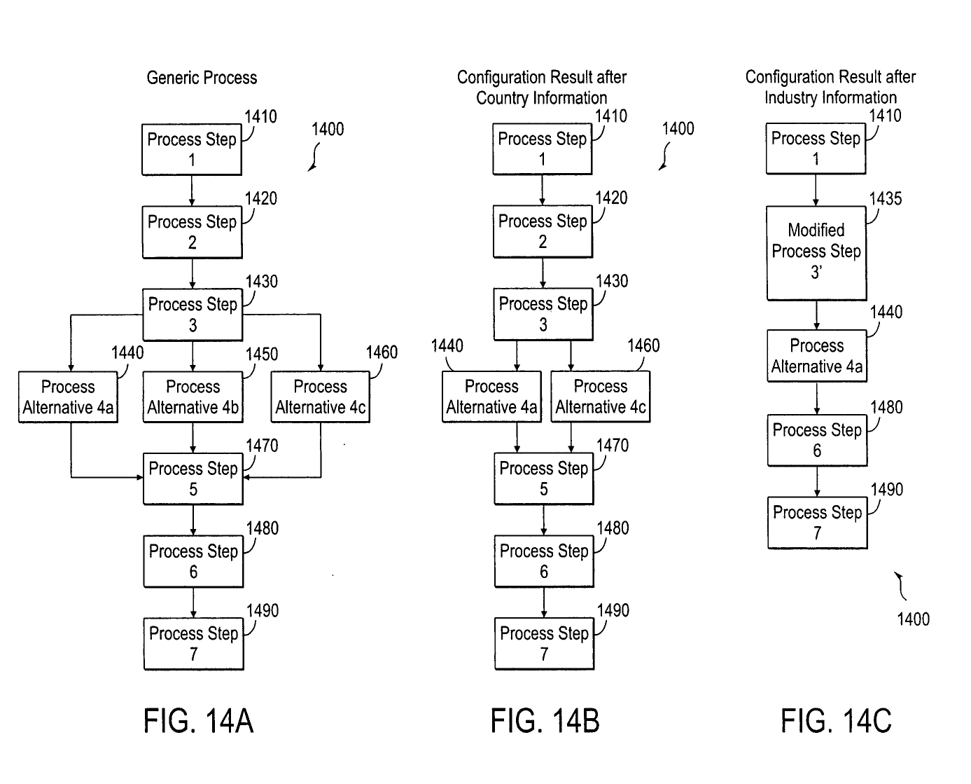

As may be expected, using multiple types of information may lead to more effective customization. FIG. 14A illustrates still another embodiment of a process which may be customized. Process 1400, as ultimately customized in FIG. 14C, uses country information and industry information to determine customization. Process 1400 initially includes an initial set of steps 1, 2 and 3 (modules 1410, 1420 and 1430), a set of alternative steps 4a, 4b and 4c (modules 1440, 1450 and 1460), and another set of steps 5, 6 and 7 (modules 1470, 1480 and 1490).

After consideration of what country a process is performed in, some parts of the process may be removed. FIG. 14B illustrates the process of FIG. 14A after customization in one embodiment. Process 1400 is illustrated in FIG. 14B as having alternate step 4b (module 1450) and step 5 (module 1470) removed. As an example, if a process contemplates international monetary exchanges, but the process is implemented in a country where no such exchanges are allowed, then an alternative step related to receiving international funds and a step related to converting international funds would be left out.

Specific industry or company information may further inform customization. FIG. 14C illustrates the process of FIG. 14B after further customization in one embodiment. Process 1400, as illustrated in FIG. 14C, has no step 2 and a modified step 3 (module 1435). Additionally, process 1400 has only one of the alternatives—step 4a (module 1440)—included. Thus, process 1400, as customized, is much simplified relative to the original process 1400 of FIG. 14A. As an example, if a business restricts transactions to cash, then the business may only need one alternative for accepting funds, and may need modified and simplified processes and process modules for handling transactions.

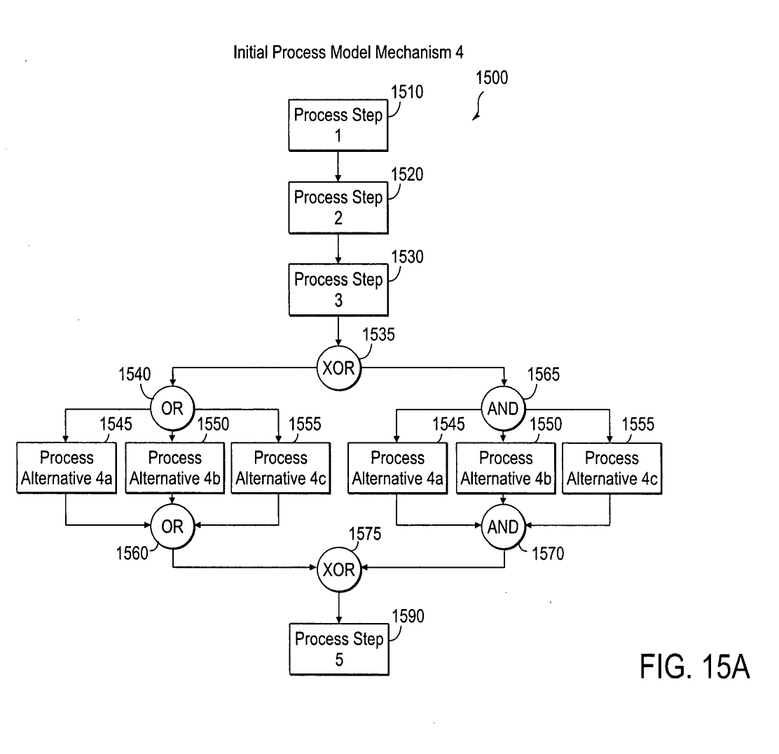

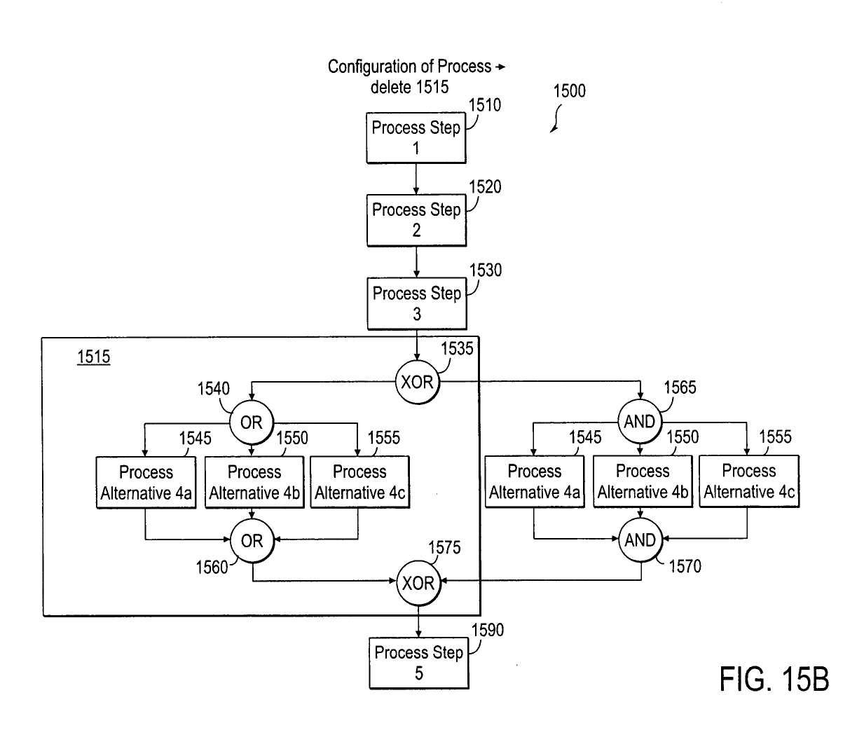

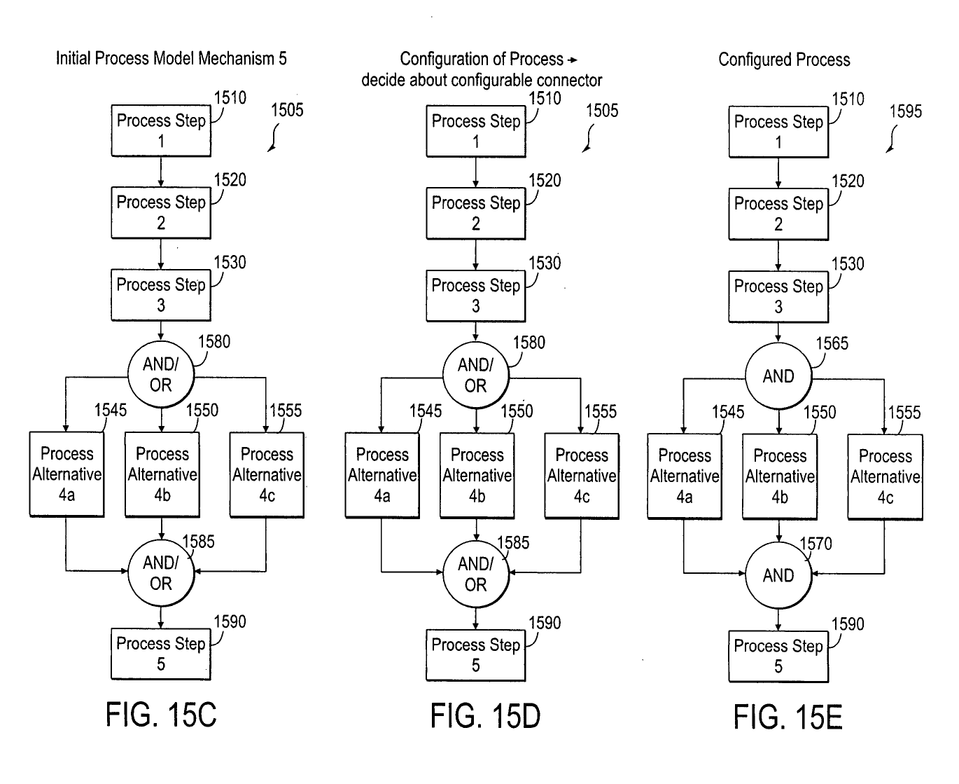

It may also be instructive to understand that different templates for processes can be customized into the same process. Note that these templates refer to both configurable models, which allow for options to be chosen within the model, and reducible models, which allow for removal of unnecessary process modules. FIG. 15A illustrates another embodiment of a process which may be customized through model model reduction. Process 1500 includes initial steps 1, 2 and 3 (modules 1510, 1520 and 1530). Process 1500 also includes exclusive-or step (module 1535)—requiring a choice of one of the two paths below it. One path, as illustrated, includes OR module 1540 allowing for one of its paths, alternative steps 4a, 4b and 4c (modules 1545, 1550 and 1555), all of which flow into OR module 1560. The other path includes AND module 1565, requiring all of its paths (presumably in parallel as illustrated), alternative steps 4a, 4b and 4c, and AND module 1570. These two alternate paths each lead to exclusive-or module 1575. The process then goes to module 1590 for process step 5. The entire section between the XOR-modules 1535 and 1575 requires that either all three steps 4a, 4b, and 4c are executed, or at least one of them is executed. Configuration of the model determines which of those options is used.

An alternate template may also be used. FIG. 15B illustrates an alternate embodiment of the process of FIG. 15A which may be customized through configuration. Process 1505 includes initial steps 1, 2 and 3. (modules 1510, 1520 and 1530). Process 1505 also includes AND/OR step (module 1580)—requiring a choice of how to traverse the paths below it. Steps 4a, 4b and 4c (modules 1545, 1550 and 1555) are then provided, for either parallel execution or alternative execution. Process 1505 then includes AND/OR step 1585, and then flows to process step 5 (module 1590). Thus, AND/OR steps 1580 and 1585 require a decision about parallel or alternative use of the intervening modules.

Note that the process models of FIGS. 15A and 15B represent the same process, as modeled in two different types of templates. Thus, FIG. 15A provides a model with all possibilities enumerated, and functions with unnecessary portions excised. FIG. 15B provides a model which requires a choice in configuration to operate, but does not involve reduction of process modules. Either type of template may be preferable in some situations. As illustrated in FIGS. 15A, 15B, 15C, 15D and 15E, one may provide the same process model with different templates as starting points.

Customization of the process of FIG. 15A involves choosing one of two paths. FIG. 15C illustrates the process of FIG. 15A after customization in one embodiment. After one of the two paths are chosen, the circled part of the process (group 1515) is removed. This provides modified process 1500, which includes AND modules 1565 and 1570 and the process alternatives (for parallel execution) in between.

Customization of the process of FIG. 15B, on the other hand, involves choosing how the process is customized at the AND/OR modules, rather than removing duplicate portions. FIG. 15D illustrates the process of FIG. 15B after customization in one embodiment. Modules 1580 and 1585 are configured for either AND (parallel) or OR (alternative) execution (presumably parallel execution here). This effectively customizes the process.

Both of the templates eventually result in the same process. FIG. 15E illustrates the resulting process of customization of the processes of FIG. 15A and 15B after customization in one embodiment. Modules 1565 and 1570 are retained in process 1500. For process 1505, modules 1580 and 1585 are specified as modules 1565 and 1570 (AND modules). Either way, the result is process 1595, as illustrated.

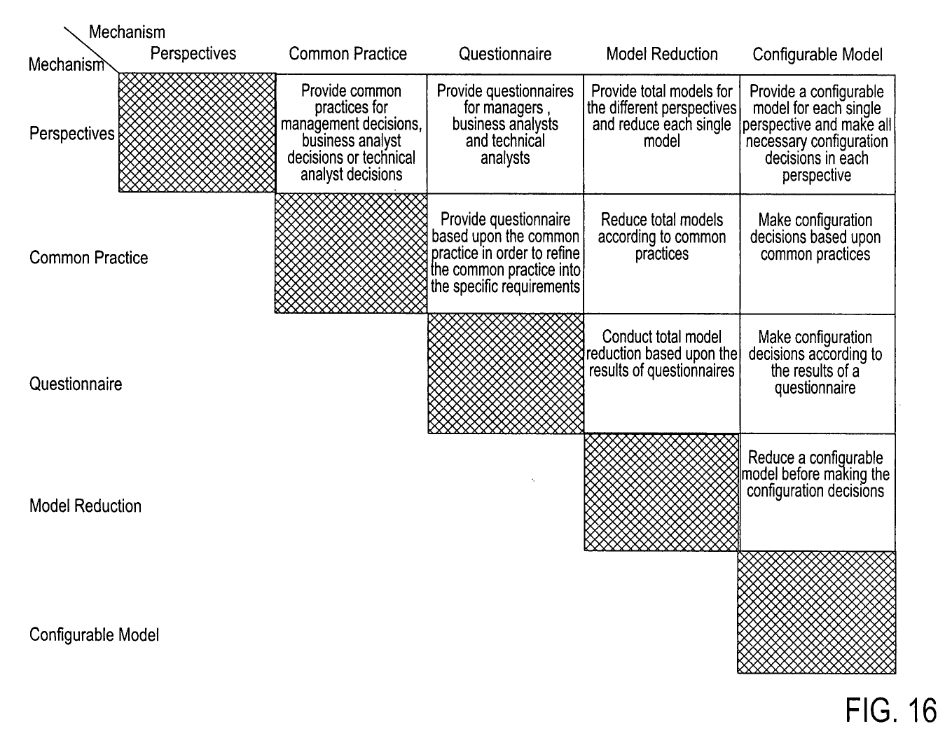

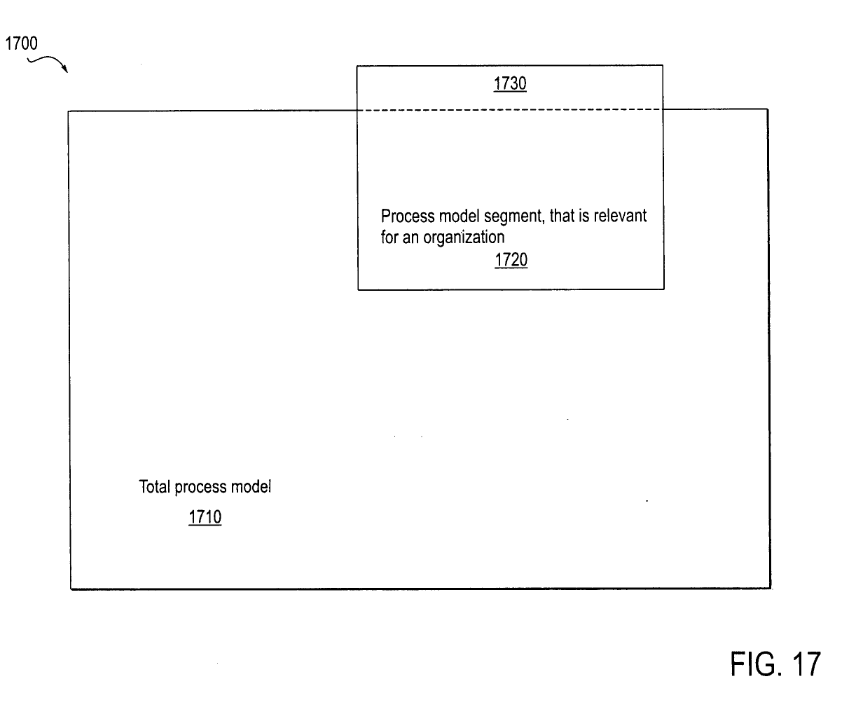

Various approaches can be used to customize templates for processes into final processes. FIG. 16 illustrates various approaches to customizing a process in various embodiments, and how combinations of such approaches provide an enhanced effect. The available options are classified into perspectives (getting general perspectives from different participants with different backgrounds), common practice (what is done in a country or an industry), questionnaires (asking a user specific questions about a template), model reduction (actually reducing the model responsive to input), and a configurable model (a model which can be configured or rearranged as opposed to simply reduced).

Blending of the various approaches is illustrated in the various boxes at the intersections of the mechanisms. Perspectives can combine with common practice to produce a common practice known to a group of people with different backgrounds. Perspective can be used with questionnaires to get specific input from a variety of backgrounds. A common practice can influence a questionnaire to focus it for a specific industry or country. Perspectives and model reduction can lead to a model with most/all possibilities for a given process area (technical, business, etc.) which can be reduced for a given process. Similarly, common practices for a subset of an area or industry can reduce a broad model, and questionnaires can inform pruning of a model.

Each perspective can be tied to a configurable model in some process areas, with technical and business models available for some processes, for example. The configurable model need not have process elements removed, rather flows of processes can be shown during development to allow for use of either internal or external models. Similarly, configuration can occur based on conventional or common practices. Questionnaires can influence or dictate configuration of a model. Model reduction combined with a configurable model can be particularly powerful, as a model may be customized for one user, and can then be used for another user without requiring replacement of an unchanging module.

Configuration, reduction and augmentation of a process may be understood with reference to sets as well. FIG. 17 illustrates an embodiment of a process and a customized process. Set 1700 includes the configurable process model 1710, the configured process 1720 and the augmented parts of the process 1730. Thus, the configured process 1720 is the portion of process model 1710 which is used in the process in question. Augmented portion 1730 is a portion which may or may not be necessary in various embodiments, and represents anything related to adding something to the process 1720 which was not available in model/process 1710. The process modeler preparing templates may not provide for all eventualities, so the customization process may allow for addition of new process modules in a process.

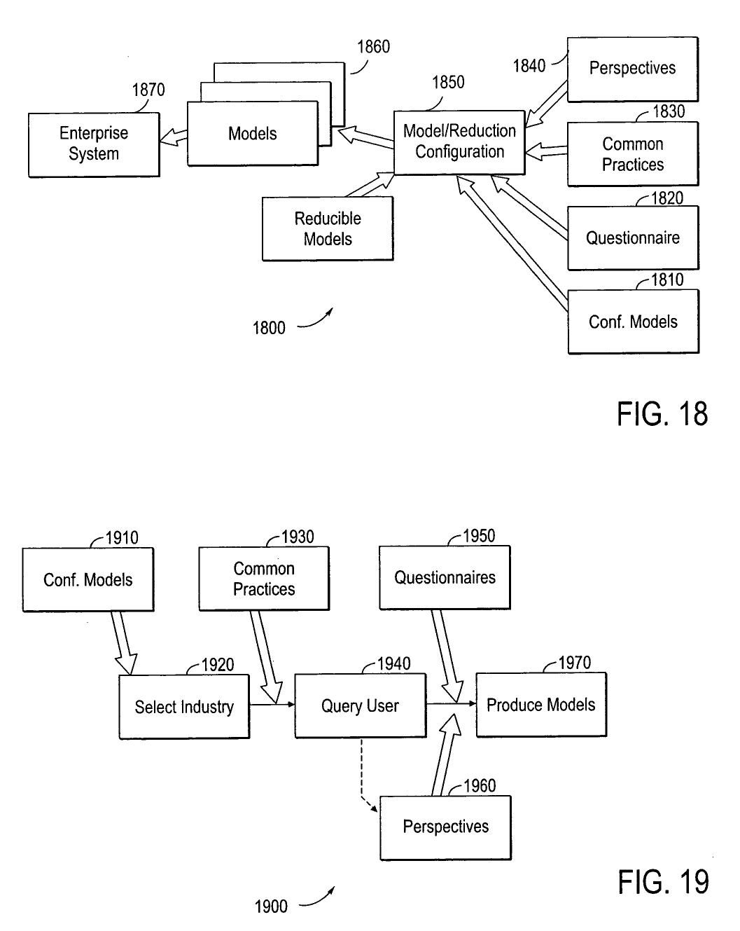

All of these customized models may be used in an enterprise system to provide functionality unique to an organization or group. FIG. 18 illustrates an embodiment of a system using customized models and the related parts of the system used to produce customized models. Configurable models 1810, reducible models 1880, questionnaires 1820, common practices 1830 and perspectives 1840 are all fed into a model reduction/configuration engine 1850 as part of system 1800. This results in a set of customized models 1860 which should represent processes of a group or organization. Enterprise system 1870 can then use these customized models 1860 to facilitate operations of the group or organization. Note that not all of modules 1810, 1820, 1830, 1840 and 1880 need be used to produce each model 1860, or even by each group or organization in general.

Producing process models can occur in a variety of ways. FIG. 19 illustrates an embodiment of a process of customizing a generic model to provide a customized model. Process 1900 includes selecting an industry, querying a user, and producing a model, and involves configurable models, common practices, questionnaires and perspectives.

Initially, an industry is selected at module 1920, resulting in selection of a configurable model 1910 from a set of such configurable models and modification of the configurable model responsive to representations of common practices 1930 of the selected industry. A user (or users) are queried at module 1940. This occurs through use of questionnaires of module 1950. Moreover, this may result in triggering use of information from perspectives module 1960, either based on answers to a questionnaire or to more general queries directed to the user. The result is production of a configured or customized model at module 1970.

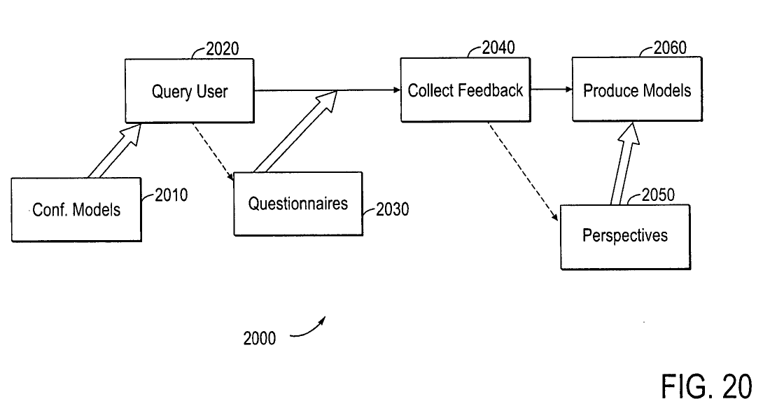

Alternatively, a process need not involve industry- or country-specific selections. FIG. 20 illustrates an alternate embodiment of a process of customizing a generic model to provide a customized model. Process 2000 includes selection of a configurable model, querying of a user using questionnaires, collecting feedback from the user, comparing the results to perspective data, and producing a suggested process model from the assembled data.

Process 2000 initiates with selection of a configurable model 2010. A user or users are queried at module 2020 to gather information about the specific process. This includes use of prepared questionnaires 2030. Feedback from queries and questionnaires is collected at module 2040, and compared with perspectives data 2050 to determine how a process should be customized. The configurable model is then customized based on the collected data and perspective data 2050 at module 2060. This process may then allow for additional customization as a result of changes needed but not addressed by the process.

One skilled in the art will appreciate that although specific examples and embodiments of the system and methods have been described for purposes of illustration, various modifications can be made without deviating from the spirit and scope of the present invention. For example, embodiments of the present invention may be applied to many different types of databases, systems and application programs. Moreover, features of one embodiment may be incorporated into other embodiments, even where those features are not described together in a single embodiment within the present document. Accordingly, the invention is described by the appended claims.

What is claimed is:

1. A method, comprising:
initially selecting a configurable process model for a process;
receiving management information related to the process responsive to a questionnaire;
receiving business information related to the process responsive to a questionnaire;
receiving technical information related to the process responsive to a questionnaire;
comparing responses to questionnaires to perspective data related to the configurable process model;
adapting the configurable process model into a specific process model to reflect the management information, business information and technical information and thereby reflect the process; and
storing the specific process model in a data repository for an enterprise system.

2. The method of claim 1, wherein:
the configurable process model is chosen based on a country of use for the process.

3. The method of claim 1, wherein:
the configurable process model is chosen based on an industry of use for the process.

4. A method, comprising:
receiving management information related to a process;
receiving business information related to the process;
receiving technical information related to the process;
adapting a generic process model into a specific process model to reflect the management information, business information and technical information; and
storing the specific process model in a data repository for an enterprise system.

5. The method of claim 4, further comprising:
providing a graphical representation of the generic process model to a user, the management information, business information, and technical information received from the user responsive to the graphical representation.

6. The method of claim 4, further comprising:
providing a management information questionnaire to a user;
providing a business information questionnaire to the user; and
providing a technical information questionnaire to the user.

7. The method of claim 4, further comprising:
reducing the generic process model into the specific process model responsive to indications from the management information, business information and technical information that portions of the generic process model are not necessary.

8. The method of claim 7, wherein:
reducing the generic process model involves deleting portions of the generic process model in the specific process model.

9. The method of claim 7, wherein:
reducing the generic process model involves flagging portions of the generic process model as unused in the specific process model.

10. The method of claim 4, further comprising:
previewing the specific process model for the user.

11. The method of claim 10, further comprising:
repeating the receiving management information,
receiving business information, and receiving technical information responsive to the previewing.

12. The method of claim 4, further comprising:
providing a management information questionnaire to a first user;
providing a business information questionnaire to a second user; and
providing a technical information questionnaire to a third user.

13. The method of claim 12, further comprising:
reducing the generic process model into the specific process model responsive to indications from the management information, business information and technical information that portions of the generic process model are not necessary.

14. The method of claim 4, further comprising:
retrieving the generic process model from the data repository for an enterprise system.

15. The method of claim 4, wherein:
the method is implemented responsive to a processor executing instructions, the instructions embodied in a machine-readable medium.

16. A method of configuring process models in a data repository related to users of an enterprise system in a company, the method comprising:
receiving business information related to a process;
receiving management information related to the process;
receiving technical information related to the process;
reducing a generic process model into a specific process model responsive to indications from the management information, business information and technical information that portions of the generic process model are not necessary;
adapting the generic process model into the specific process model to reflect the management information, business information and technical information; and
storing the specific process model in the data repository.

17. The method of claim 16, further comprising:
providing a management information questionnaire to a user;
providing a business information questionnaire to the user; and
providing a technical information questionnaire to the user.

18. The method of claim 16, further comprising:
providing a management information questionnaire to a first user;
providing a business information questionnaire to a second user; and
providing a technical information questionnaire to a third user.

19. The method of claim 16, further comprising:
providing a graphical representation of the generic process model to a user, the management information, business information, and technical information received from the user responsive to the graphical representation.

20. The method of claim 16, further comprising:
previewing the specific process model for a user.
